(19) United States
(12) Patent Application Publication
(10) Pub. No.: US 2020/0079573 A1
(43) Pub. Date: Mar. 12, 2020

(54) HEATING CONTAINER FOR COOKING FOOD

(71) Applicant: Honest Food Co., Ltd., Jeollabuk-do (KR)

(72) Inventor: Su Seok Kim, Jeollabuk-do (KR)

(21) Appl. No.: 16/127,539

(22) Filed: Sep. 11, 2018

(51) Int. Cl. B65D 81/34; A47J 27/00; A47J 27/05; A47J 27/026; A47J 27/022

(52) U.S. Cl. CPC B65D 81/3484; A47J 27/002; A47J 27/05; B65D 2581/34; A47J 27/022; A47J 2201/00; B65D 2581/051; A47J 27/026

(57) ABSTRACT

The present disclosure relates to a heating container for cooking food including an outer container, a heating agent container which provides an internal space for receiving a heating agent, an inner container which is received in an internal space of the outer container, and a lid which is separably connected with the outer container to close an open top of the inner container, wherein the outer container includes an outer container bottom having a bottom opening, and an outer container sidewall which extends upward from the outer container bottom, and the heating agent container is separably connected to the outer container such that at least part extrudes outward through the bottom opening.

### BACKGROUND OF THE INVENTION

### Field of the Invention

The present disclosure relates to a container for cooking food, and more particularly, to a heating container for heating food using a heating agent.

### Description of the Related Art

The common way to heat food outdoors is to heat cookware in which food is received using a heating tool such as a gas range or a burner. However, this common way to heat food requires the separate use of the cookware and the heating tool, and it is inconvenient in carrying and keeping. To reduce the inconvenience, heating containers have been developed, which are designed to heat food using a heating agent that produces heat by hydration reaction when contacted with water without using a separate heating tool such as a gas range or a burner.

The conventional heating container using a heating agent generally includes an outer container in which a heating agent and water are received, and an inner container which is received the outer container and in which food to be heated is received, and because the outer container needs to receive both the heating agent and the inner container, the relatively large outer container is used, so improvement is required.

### SUMMARY OF THE INVENTION

The present disclosure is directed to providing a heating container for cooking food using a heating agent with a more convenient carrying and keeping structure.

To achieve the above-described object of the present disclosure, according to an aspect of the present disclosure, there is provided a heating container for cooking food including an outer container, a heating agent container which provides an internal space for receiving a heating agent, an inner container which is received in an internal space of the outer container, and a lid which is separably connected with the outer container to close an open top of the inner container, wherein the outer container includes an outer container bottom having a bottom opening, and an outer container sidewall which extends upward from the outer container bottom, and the heating agent container is separably connected to the outer container such that at least part protrudes outward through the bottom opening.

The heating agent container may include a heating agent container bottom, a heating agent container sidewall which extends upward from the heating agent container bottom, and a heating agent container connection part which extends outward from the heating agent container sidewall so that it is put on an inner end of the outer container bottom.

The outer container bottom may have a stop protrusion protruding upward on an inner side, and the heating agent container connection part may be in a shape of a groove which surrounds the stop protrusion.

The inner container may include an inner container bottom, an inner container sidewall which extends upward from the inner container bottom, and an inner container connection part which extends outward from the inner container sidewall and is separably connected to an upper end of the outer container sidewall.

When the inner container connection part is connected to the upper end of the outer container sidewall, the outer container sidewall and the inner container sidewall may be spaced apart from each other.

The outer container may further include a plurality of outer container wings which protrudes outward from the outer container sidewall, the lid may include a plurality of connection wings corresponding to the outer container wings, one of the outer container wing and the connection wing may have a connection groove and the other may have an insertion protrusion which is separably inserted into the connection groove.

The heating agent container may have a size that it can be received in the inner container.

According to the present disclosure, all the objects of the present disclosure previously described can be achieved. Specifically, the heating agent container for receiving a heating agent is separately provided such that it can be separated from the outer container and the heating agent container has a size that it can be received in the inner container, and thus the volume of the outer container is reduced and the inner container and the heating agent container can be received together in the outer container having the reduced volume, and accordingly it is convenient to carry and keep.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a perspective view of a heating container for cooking food according to an embodiment of the present disclosure.

FIG. 2 is a vertical cross-sectional view of the heating container for cooking food shown in FIG. 1.

FIG. 3 is an exploded perspective view of the heating container for cooking food shown in FIG. 1.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

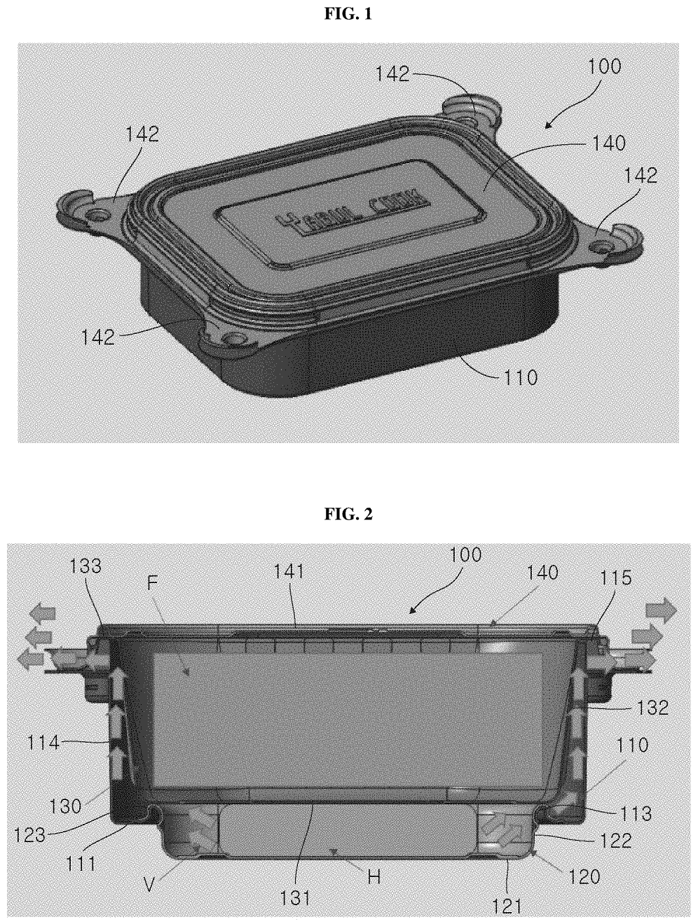

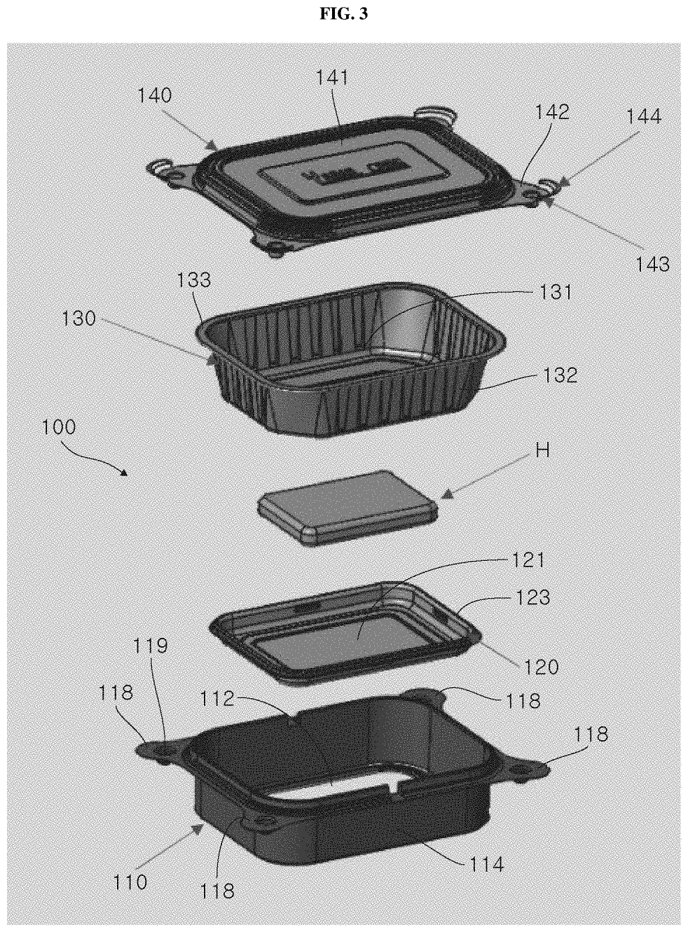

FIGS. 1, 2 and 3 are a perspective view, a vertical cross-sectional view and an exploded perspective view of a heating container for cooking food according to an embodiment of the present disclosure, respectively. FIGS. 1 to 3 are diagrams showing a heating container using a heating agent according to an embodiment of the present disclosure. Referring to FIGS. 1 to 3, the heating container 100 for cooking food according to an embodiment of the present disclosure includes an outer container 110, a hating agent container 120 for receiving a heating agent H, an inner container 130 for receiving food F to be heated, and a lid 140. The heating container 100 heats the food F using the heating agent H.

The outer container 110 includes an outer container bottom 111, an outer container sidewall 114 that extends upward from the edge of the outer container bottom 111, and a plurality of outer container wings 118 that protrudes outward from the outer container sidewall 114. The outer container 110 provides an internal space formed by the outer container bottom 111 and the outer container sidewall 114, and the inner container 130 is received in the internal space. The top of the outer container 110 is open to form an opening, and the heating agent container 120 and the inner container 130 can go in and out through the opening formed on the top of the outer container 110. Although this embodiment describes that the outer container 110 is a container which is generally rectangular in shape, the present disclosure is not limited thereto.

The outer container bottom 111 is in the shape of a generally flat plate, and the outer container bottom 111 has, at the central part, a bottom opening 112 through which the internal space of the outer container 110 is in communication with the outside. The outer container bottom 111 has, at an inner end, a stop protrusion 113 that protrudes upward to the internal space of the outer container 110. The heating agent container 120 is put on the stop protrusion 113 and is connected with the outer container 110.

The outer container sidewall 114 extends upward from the edge of the outer container bottom 111. The inner container 130 is put on an upper end 115 of the outer container sidewall 114 and is received in the internal space of the outer container 110.

Each of the plurality of outer container wings 118 protrudes outward from the outer container sidewall 114. Although this embodiment describes that the plurality of outer container wings 118 is disposed at the four corners of the upper part of the rectangular shaped outer container 110, the present disclosure is not limited thereto. Each of the plurality of outer container wings 118 has a connection groove 119 for connection with the lid 140 on an upper surface.

The heating agent container 120 includes a heating agent container bottom 121, a heating agent container sidewall 122 that extends upward from the edge of the heating agent container bottom 121, and a heating agent container connection part 123 that extends outward from the upper end of the heating agent container sidewall 122. The heating agent H is received in an internal space of the heating agent container 120 formed by the heating agent container bottom 121 and the heating agent container sidewall 122. The top of the heating agent container 120 is open to form an opening. The heating agent H that is received in the heating agent container 120 refers to a heating agent that produces heat by hydration reaction when contacted with water. That is, for heating purpose, water is received in the heating agent container 120 together with the heating agent H. The heating agent container connection part 123 has a shape of a ring type groove that surrounds the stop protrusion 113 of the outer container 110. Separation and re-connection can be accomplished by elastic deformation of at least one of the heating agent container connection part 123 and the stop protrusion 113 of the outer container 110. When the heating agent container connection part 123 is connected to the stop protrusion 113, the heating agent container bottom 121 and the heating agent container sidewall 122 protrude downward and through the bottom opening 112 of the outer container 110 are exposed to the outside. The food F received in the inner container 130 is heated by the heating agent H received in the heating agent container 120. The heating agent container 120 has a size that it can be received in the inner container 130.

The inner container 130 includes an inner container bottom 131, an inner container sidewall 132 that extends upward from the edge of the inner container bottom 131, and an inner container connection part 133 that extends outward from the upper end of the inner container sidewall 132. The food F to be heated is received in an internal space of the inner container 130 formed by the inner container bottom 131 and the inner container sidewall 132. The inner container bottom 131 and the inner container sidewall 132 have a size that they can be received in the internal space of the outer container 110. The inner container connection part 133 has a shape of a ring type groove that surrounds the upper end of the outer container sidewall 114. In connected state in which the inner container connection part 133 is put on the upper end of the outer container sidewall 114, the inner container 130 is received in the internal space of the outer container 110, and the inner container sidewall 132 is spaced apart from the outer container sidewall 114. A space formed between the inner container sidewall 132 and the outer container sidewall 114 forms a passage through which vapor and gas V produced by the heating agent H moves. The lower surface of the inner container bottom 131 is in contact with the heating agent container connection part 123 so that the heating agent container 130 maintains the stably connected state.

The lid 140 includes a lid part 141 that closes the open top of the inner container 130 when the inner container 130 is received in the outer container 110, and a plurality of connection wings 142 that extends from the edge of the lid 141, each corresponding to the plurality of outer container wings 118. Each of the plurality of connection wings 142 has an insertion protrusion 143 that is separably inserted into the connection groove 119 formed in the outer container wing 118. Each connection wing 142 has a handle 144 that is spaced apart from the outer container wing 118. With the handle 144, a user can pull the lid 140 connected to the outer container 110 and separate it. Although the above embodiment describes that the connection wing 142 of the lid 140 has the insertion protrusion 143 and the outer container wing 118 has the connection groove 119, on the contrary, the insertion protrusion may be formed in the outer container wing 118, and the connection groove 119 may be formed in the connection wing 142 of the lid 140.

In carrying and keeping the heating container 100, the heating agent container 120 that is separate from the outer container 110 can be received in the inner container 130 with the inner container 130 being received in the outer container 110, and thus the volume of the outer container 110 can be reduced, and portability and mobility are remarkably improved compared to conventional heating containers.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A heating container for cooking food comprising:
an outer container;
a heating agent container which provides an internal space for receiving a heating agent;
an inner container which is received in an internal space of the outer container; and
a lid which is separably connected with the outer container to close an open top of the inner container,
wherein the outer container includes an outer container bottom having a bottom opening, and an outer container sidewall which extends upward from the outer container bottom,
wherein the heating agent container is separably connected to the outer container such that at least part extrudes outward through the bottom opening.

2. The heating container for cooking food of claim 1, wherein the heating agent container includes a heating agent container bottom, a heating agent container sidewall which extends upward from the heating agent container bottom, and a heating agent container connection part which extends outward from the heating agent container sidewall so that it is put on an inner end of the outer container bottom.

3. The heating container for cooking food of claim 1, wherein the outer container bottom has a stop protrusion protruding upward on an inner side, and the heating agent container connection part is in a shape of a groove which surrounds the stop protrusion.

4. The heating container for cooking food of claim 1, wherein the inner container includes an inner container bottom, an inner container sidewall which extends upward from the inner container bottom, and an inner container connection part which extends outward from the inner container sidewall and is separably connected to an upper end of the outer container sidewall.

5. The heating container for cooking food of claim 1, wherein when the inner container connection part is connected to the upper end of the outer container sidewall, the outer container sidewall and the inner container sidewall are spaced apart from each other.

6. The heating container for cooking food of claim 1,
wherein the outer container further includes a plurality of outer container wings which protrudes outward from the outer container sidewall,
wherein the lid includes a plurality of connection wings corresponding to the outer container wings,
wherein each of the plurality of connection wings includes a handle which is spaced apart from the outer container wings, and the lid connected to the outer container is separated by pulling using the handle,
wherein one of the outer container wing and the connection wing has a connection groove, and the other has an insertion protrusion which is separably inserted into the connection groove.

7. The heating container for cooking food of claim 1, wherein the heating agent container has a size that it can be received in the inner container.

8. A heating container for cooking food comprising:
an outer container comprising:
an outer container bottom having a bottom opening; and
an outer container sidewall which extends upward from the outer container bottom;
a heating agent container providing an internal space for receiving a heating agent;
an inner container positioned inside of the outer container; and
a lid separably connected with the outer container.

9. The heating container for cooking food of claim 8, wherein the heating agent container is separably connected to the outer container such that at least part extrudes outward through the bottom opening.

10. The heating container for cooking food of claim 8, wherein the heating agent container includes a heating agent container bottom, a heating agent container sidewall which extends upward from the heating agent container bottom, and a heating agent container connection part which extends outward from the heating agent container sidewall so that it is put on an inner end of the outer container bottom.

11. The heating container for cooking food of claim 8, wherein the outer container bottom has a stop protrusion protruding upward on an inner side, and the heating agent container connection part is in a shape of a groove which surrounds the stop protrusion.

12. The heating container for cooking food of claim 8, wherein the inner container includes an inner container bottom, an inner container sidewall which extends upward from the inner container bottom, and an inner container connection part which extends outward from the inner container sidewall and is separably connected to an upper end of the outer container sidewall.

13. The heating container for cooking food of claim 8, wherein when the inner container connection part is connected to the upper end of the outer container sidewall, the outer container sidewall and the inner container sidewall are spaced apart from each other.

14. The heating container for cooking food of claim 8,
wherein the outer container further includes a plurality of outer container wings which protrudes outward from the outer container sidewall,
wherein the lid includes a plurality of connection wings corresponding to the outer container wings,
wherein each of the plurality of connection wings includes a handle which is spaced apart from the outer container wings, and the lid connected to the outer container is separated by pulling using the handle,
wherein one of the outer container wing and the connection wing has a connection groove, and the other has an insertion protrusion which is separably inserted into the connection groove.

15. The heating container for cooking food of claim 8, wherein the heating agent container has a size that it can be received in the inner container.
